(19) United States
(12) Patent Application Publication
(10) Pub. No.: US 2026/0116017 A1
(43) Pub. Date: Apr. 30, 2026

(54) MAGNETIC HEATING APPARATUS FOR INSULATION PANEL FABRICATION

(71) Applicant: Kalwall Corporation, Manchester, NH (US)

(72) Inventors: Marcus William Susalka HEROLD, Merrimack, NH (US); John William MCKENNA, Manchester, NH (US)

(73) Assignee: Kalwall Corporation, Manchester, NH (US)

(21) Appl. No.: 18/926,561

(22) Filed: Oct. 25, 2024

(51) Int. Cl. B29C 65/36; H05B 6/10

(52) U.S. Cl. CPC B29C 65/3668; H05B 6/109

(57) ABSTRACT

A magnetic heating apparatus which comprises a first rotor supporting first permanent magnets and a mating first rotor supporting second permanent magnets. The first and second permanent magnets both are arranged in alternating directions such that each pair of magnets, located directly on either side of any one of the first permanent magnets, have opposite polarities from a polarity of the magnet located therebetween. The first and the second permanent magnets are spaced from and define a panel passageway therebetween which facilitates passage of an assembled insulation panel, having a metallic core, therethrough. A first rotor drive rotates the first rotor, supporting the first permanent magnets, relative to the mating first rotor, supporting the second permanent magnets, to generate a changing magnetic field, in the panel passageway, for directly heating the metallic core of the assembled insulation panel as the panel passes therethrough without heating the non-metallic components.

### BACKGROUND OF THE INVENTION

### Field of the Invention

The present invention relates to a magnetic heating apparatus and a method for heating a metallic (aluminum) core, by generated magnetic fields such as eddy currents, in order to soften a heat activated bonding adhesive, applied to opposed faces of the metallic core, and adhere a pair of fiberglass reinforced polymer sheets to the opposed faces of the metallic core and thereby complete the fabrication of a (translucent) insulation panel.

### Description of Related Prior Art

As is known in the prior art, the (translucent) insulation panels are designed to permit exterior natural lighting, from the sun for example, to pass therethrough and at least partially illuminate an interior space incorporating one or more of the (translucent) insulation panels while, at the same time, still providing adequate insulation from the external environment. Since these (translucent) insulation panels are partially transparent, the metallic core, sandwiched between the pair of opposed fiberglass sheets, is partially visible through the fiberglass sheet and, accordingly, the bond formed between the fiberglass sheet and the mating metallic core is of particular importance in achieving an aesthetically pleasing and appealing (translucent) insulation panel.

As is also well known, conventional (translucent) insulation panels 2 (see FIG. 1) are manufactured from a metallic core 4 which comprises at least two longitudinal I-beam shaped side rails 6 which are arranged parallel to one another and interconnected with one another by a plurality of I-beam shaped transverse rails 8. Each one of the plurality of I-beam shaped transverse rails 8 extends normal to the longitudinal side rails 6 and thereby divide the metallic core into a plurality of separate/individual rectangular shaped compartments 10.

During final assembly of the (translucent) insulation panel 2, after formation of the metallic core 4, a powder, a liquid or a gel bonding adhesive 16, which is designed to soften at an elevated temperature, is applied over an entire first face 12 of the metallic core 4. Thereafter, a first reinforced polymer fiberglass sheet 18 is brought into intimate engagement with the bonding adhesive 16 applied to the first face 12 of the metallic core 4. Next, the partially formed (translucent) insulation panel 2 is then flipped over so that each one of the compartments 10 may be filled with a suitable (translucent) insulating material 20, such as fiberglass or aerogel, then additional powder, liquid or gel bonding adhesive 16, which is designed to soften at an elevated temperature, is applied over the entire opposed second face 14 of the metallic core 4. Finally, a second fiberglass reinforced polymer sheet 22 then is brought into intimate engagement with the bonding adhesive 16, applied to the second face 14 of the metallic core 4, to complete assembly of the desired (translucent) insulation panel 2.

Thereafter, the assembled (translucent) insulation panel 2 passes through a heating oven which is designed to heat the entire (translucent) insulation panel 2 and thereby soften and activate the bonding adhesive 16. The heating oven typically comprises a conventional heating method, such as IR or convection heating, in order to heat the upper and lower surfaces of the entire (translucent) insulation panel, to a desired temperature, in order to activate the bonding adhesive, as the (translucent) insulation panel passes through the heating oven. Once the (translucent) insulation panel 2 has been sufficiently heated within the oven, then the (translucent) insulation panel 2 exits therefrom and the fiberglass sheets 18, 22 come into intimate contact with the softened bonding adhesive 16, carried or supported by the opposed faces 12, 14 of the metallic core 4, and thereby bonds the fiberglass sheets 18, 22 thereto. As the bonding adhesive 16 cools, a permanent bond between the fiberglass sheets 18, 22 and the respective faces 12, 14 of the metallic core 4, is formed.

During use, the manufactured (translucent) insulation panel 2 is then secured to a structure, in a conventional manner, by associated hardware 23 (not shown in detail).

### SUMMARY OF THE INVENTION

Wherefore, it is an object of the present invention to overcome the above mentioned shortcomings and drawbacks associated with the prior art techniques and provide a new bonding apparatus and method which directly heats the metallic core—without directly heating any of the remaining components of the (translucent, opaque, metal or insulated glass units) insulation panel—so that the metallic core, in turn, can indirectly transfer and/or convey a portion of the absorbed heat into the bonding adhesive and thereby sufficiently soften the bonding adhesive and facilitate permanent bonding of the fiberglass sheets to the opposed faces of the metallic core.

Another object of the present invention is to minimize the amount of electricity that is utilized in order to heat sufficiently the bonding adhesive, carried or supported by opposed faces of the metallic core, while still ensuring a uniform, consistent and aesthetically pleasing bond of the opposed fiberglass sheets to the opposed faces of the metallic core in a cost effective manner.

A further object of the present invention is to increase the overall production speed and/or rate of final assembly of the (translucent, opaque, metal or insulated glass units) insulating panels while minimizing the amount of electricity consumed in order to achieve the same.

Yet another object of the present invention is to concentrate the generated heat in only the metallic core, as well as the bonding adhesive applied to the opposed faces of the metallic core, while generally avoiding heating the two opposed insulated glass units, metal or translucent or opaque) fiberglass sheets, the insulation or any portion of the magnetic heating apparatus.

The present invention also relates to a magnetic heating apparatus comprising: a first rotor supporting a plurality of first permanent magnets in alternating directions about a periphery thereof such that each pair of magnets, located directly on either side of any one of the first permanent magnets, have the same polarity which is opposite to a polarity of the magnet located therebetween; the plurality of first permanent magnets being spaced a panel passageway which facilitates passage of an assembled insulation panel, having a metallic core, therethrough; and a first rotor drive for rotating the first rotor, supporting the plurality of first permanent magnets, relative to the panel passageway in order to generate a changing magnetic field, in the panel passageway, for directly heating the metallic core of the assembled insulation panel as the assembled insulation panel passes therethrough.

.The present invention also relates to a magnetic heating apparatus comprising: a first rotor supporting a plurality of first permanent magnets; a mating first rotor supporting a plurality of second permanent magnets; polarities of the first plurality of permanent magnets, supported by the first rotor, being arranged in alternating directions such that each pair of magnets, located directly on either side of any one of the first plurality of permanent magnets, have the same polarity which is opposite to a polarity of the magnet located therebetween, while polarities of the plurality of second permanent magnets, supported by the mating first rotor, being arranged in alternating directions such that each pair of magnets, located directly on either side of any one of the second plurality of magnets, have the same polarity which is opposite to a polarity of the magnet located therebetween; the plurality of first permanent magnets of the first rotor being spaced from the plurality of second permanent magnets of the mating first rotor so as to define a panel passageway therebetween which facilitates passage of an assembled insulation panel, having a metallic core with opposed faces thereof having a heat activated adhesive applied thereto, and a pair of fiberglass sheets sandwiching the metallic core with the heat activated adhesive therebetween; a first rotor drive for rotating the first rotor, supporting the plurality of first permanent magnets in a first rotatable direction, and a mating first rotor drive for rotating the mating first rotor, supporting the plurality of second permanent magnets, in an opposite second rotatable direction in order to generate a changing magnetic field, in the panel passageway, for directly heating the metallic core of the assembled insulation panel, as the assembled insulation panel passes therethrough, and thereby indirectly heating the heat activated adhesive, applied to opposed faces of the metallic core, to facilitate bonding of the pair of fiberglass sheets to the metallic core.

The present invention also relates to a method of magnetic heating an assembled insulation panel, the method comprising: a first rotor supporting a plurality of first permanent magnets; a mating first rotor supporting a plurality of second permanent magnets; supporting polarities of a first plurality of permanent magnets, supported by a first rotor, in alternating directions such that each pair of magnets, located directly on either side of any one of the first plurality of permanent magnets of the first rotor, have the same polarity which is opposite to a polarity of the magnet located therebetween, while polarities of a plurality of second permanent magnets, supported by a mating first rotor, being arranged in alternating directions such that each pair of magnets, located directly on either side of any one of the second plurality of magnets, have the same polarity which is opposite to a polarity of the magnet located therebetween; spacing the plurality of first permanent magnets of the first rotor from the plurality of second permanent magnets of the mating first rotor so as to define a panel passageway therebetween which facilitates passage of an assembled insulation panel, having a metallic core with opposed faces thereof having a heat activated adhesive applied thereto, and a pair of fiberglass sheets sandwiching the metallic core with the heat activated adhesive therebetween; rotating the first rotor, supporting the plurality of first permanent magnets in a first rotational direction, and rotating the mating first rotor, supporting the plurality of second permanent magnets, in an opposite second rotational direction in order to generate a changing magnetic field, in the panel passageway; and directly heating the metallic core of the assembled insulation panel as the assembled insulation panel passes therethrough, and thereby indirectly heating the heat activated adhesive, applied to opposed faces of the metallic core, to facilitate bonding of the pair of fiberglass sheets to the metallic core.

### BRIEF DESCRIPTION OF THE DRAWINGS

The accompanying drawings, which are incorporated in and constitute a part of the specification, illustrate various embodiments of the invention and together with the general description of the invention given above and the detailed description of the drawings given below, serve to explain the principles of the invention. It is to be appreciated that the accompanying drawings are not necessarily to scale since the emphasis is instead placed on illustrating the principles of the invention. The invention will now be described, by way of example, with reference to the accompanying drawings in which:

FIG. 1 is a diagrammatic view showing the various components of a (translucent) insulation panel;

FIG. 2 is a diagrammatic side elevational view of the magnetic heating apparatus according to the disclosure;

FIG. 3 is a diagrammatic top plan view of the first framework, of the magnetic heating apparatus according to FIG. 2, showing a single conveyor belt, overlying the magnets and metallic rotors, for conveying the assembled (translucent) insulation panel (not shown);

FIG. 4 is a diagrammatic top plan view of the first framework of FIG. 3 with the single conveyor belt being removed to facilitate viewing of the two metallic rotors and the array of magnets;

FIG. 5 is a diagrammatic top plan view of the first framework, of the magnetic heating apparatus according to FIG. 2, showing a plurality of spaced apart conveyor belts, overlying the magnets and metallic rotors, for conveying the assembled (translucent) insulation panel (not shown);

FIG. 6 is a diagrammatic top plan view of the first framework, of the magnetic heating apparatus according to another embodiment, showing additional lateral sections and conveyor belts for conveying wider assembled (translucent) insulation panels; and

FIG. 7 is a diagrammatic top plan view of the first framework, of the magnetic heating apparatus according to still another embodiment, showing additional longitudinal sections with longer conveyor belts for increasing the throughput production speed of the magnetic heating apparatus.

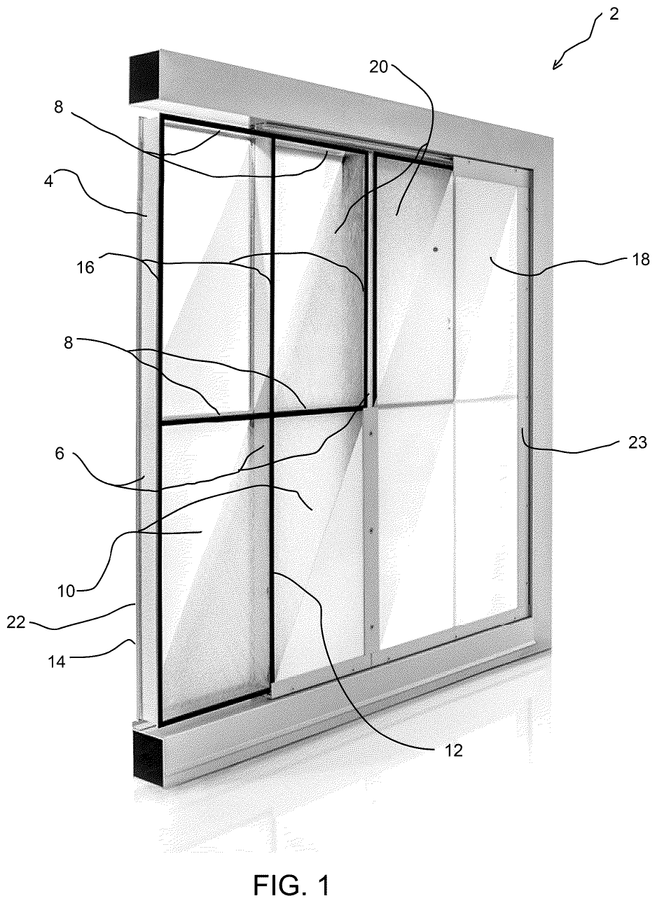

It should be understood that the drawings are not necessarily to scale and that the disclosed embodiments are sometimes illustrated diagrammatically and in partial views. In certain instances, details which are not necessary for an understanding of this disclosure or which render other details difficult to perceive may have been omitted. It should be understood, of course, that this disclosure is not limited to the particular embodiments illustrated herein.

### DETAILED DESCRIPTION OF THE INVENTION

The present invention will be understood by reference to the following detailed description, which should be read in conjunction with the appended drawings. It is to be appreciated that the following detailed description of various embodiments is by way of example only and is not meant to limit, in any way, the scope of the present invention.

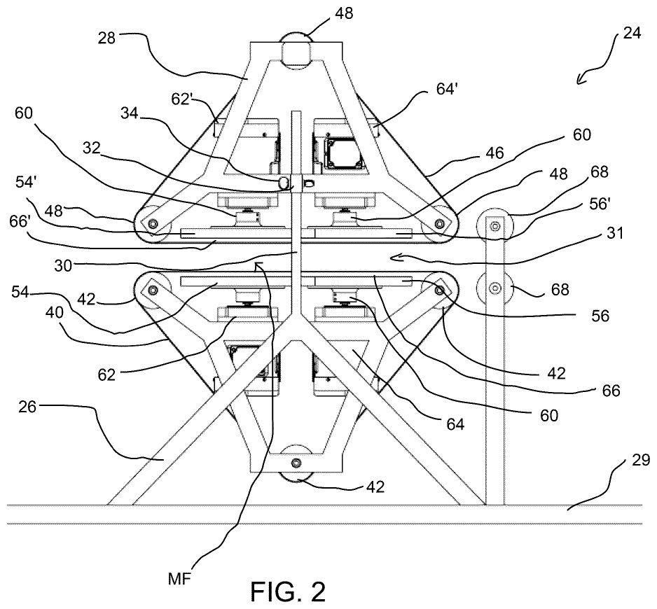

Turning now to FIGS. 2-4, a brief description concerning the various components of the magnetic heating apparatus 24 will now be discussed. As shown in these Figures, the magnetic heating apparatus 24 comprises a stationary first (steel) framework 26 and a movable second (steel) framework 28. The second framework 28 is movable or adjustable (e.g., vertically) with respect to the first framework 26, which is typically supported by the floor or some other conventional supporting surface 29. While the second framework 28 is shown as being vertically adjustable with respect to the first framework 26, it is to be appreciated that the first and the second frameworks 26, 28 can both be located in a horizontal plane and movable horizontally with respect to one another or at in a variety of other different positional arrangements. The important feature is that typically some sort of relative adjustment is provided, between the first and the second frameworks 26, 28, in order to facilitate adjustment of the height or size of a panel passageway 31 which is defined and formed therebetween. Such adjustment facilitates passage of assembled (translucent, opaque, metal or insulated glass units) insulation panels 2, having different thicknesses and/or sizes, therethrough with minimal clearance.

As shown in the drawings, in order to facilitate movement or adjustment of the second framework 28 relative to the first framework 26, a pair of spaced apart posts 30 are supported by the first framework 26 while the second framework 28 is provided with a pair of mating collars 32 which captively surround and slidingly receive and engage with a respective one of the pair of posts 30. Each one of the sliding collars 32 is provided with at least one tightening set screw or wingnut 34, for example, passing through a threaded hole (not shown in detail) formed in the sidewall of the respective collar 32, and possibly a through hole in the post 30, to facilitate retaining the second framework 28 in a desired adjusted position with respect to the associated post 30 of the first framework 26, once the set screws or wingnuts 34 are sufficiently tightened. As noted above, the space between the first and the second frameworks 26, 28 defines the panel passageway 31 and, by such arrangement, a height of the panel passageway 31 is adjustable so as to permit passage of different heights or thicknesses of assembled (translucent) insulation panels 2, to be manufactured, therethrough with minimal clearance, the purpose of which will become apparent from the following description.

It is to be appreciated that the positions of the post 30 and the collar 32 may be reversed, e.g., the pair of spaced apart posts 30 may be supported by the second framework 28 while the pair of mating collars 32 may be supported by the first framework 26. Further, those alternative arrangements are merely a few possible embodiments of providing the desired adjustment or movement of the second framework 28 relative to the first framework 26 in order to adjust the height of the panel passageway 31. It will be apparent that there are a number of other arrangements, which would also be suitable and readily apparent to those skilled in the art, in order to achieve the desired adjustment or movement of the second framework 28 relative to the first framework 26, without departing from the spirit and scope of the present disclosure.

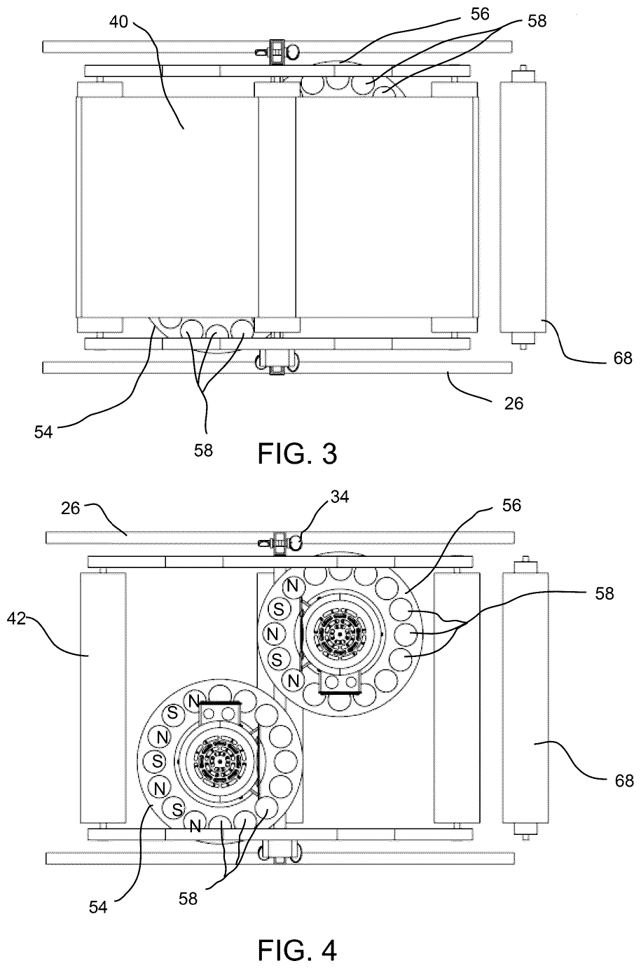

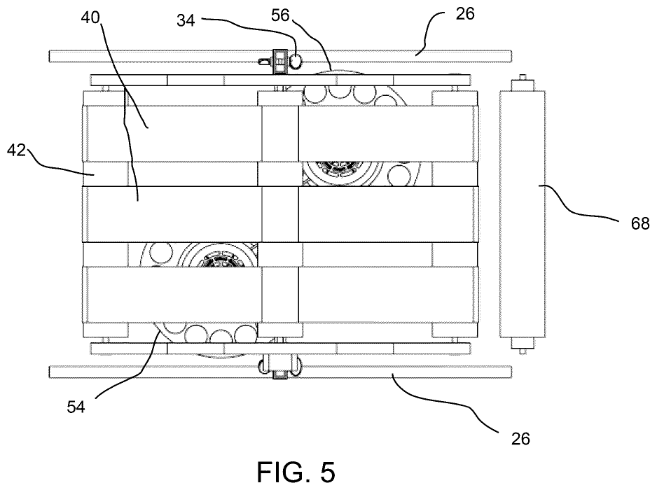

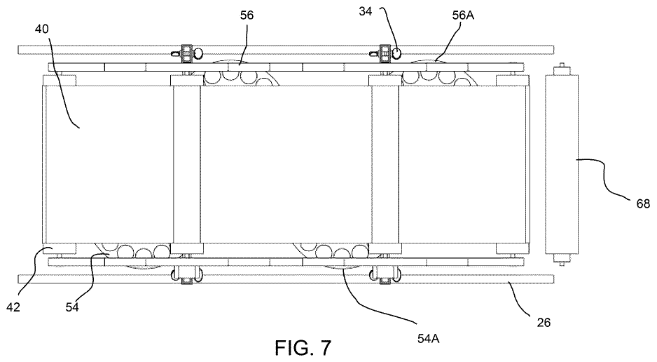

As shown, the first framework 26 is equipped with a first conveyer belt 40 which facilitates conveying of the assembled (translucent) insulating panel 2, to be manufactured, through the panel passageway 31 of the magnetic heating apparatus 24 during the heating process. The first conveyer belt 40 is supported by a plurality of rollers 42 (e.g., a drive roller, a return roller, a tensioning roller) and one of the rollers 42 is driven by a first conveyor motor (not shown in detail). In addition, the second framework 28 is equipped with a second conveyor belt 46 which also facilitates conveying of the (translucent) insulating panel 2, to be manufactured, through the magnetic heating apparatus 24 during the heating process. The second conveyer belt 46 is also supported by a plurality of rollers 48 (e.g., a drive roller, a return, roller, a tensioning roller) and one of the rollers 48 is driven by a second conveyor motor (not shown in detail). Each of the first and the second conveyor belts 40, 46 may either comprise a single continuous belt, which extends substantially across an entire width of the respective rollers 42 or 48 (see FIG. 3), or may comprise two or more smaller width conveyer belts which are located spaced apart from but adjacent one another and together combine to extend substantially across the full width of the respective rollers 42 or 48 (see FIG. 5) to facilitate conveying of the assembled (translucent) insulation panel 2 through the panel passageway 31 of the magnetic heating apparatus 24.

As shown in FIGS. 2, 3 and 4 for example, the first framework 26 supports first and second spaced apart metallic rotors 54, 56 which both generally lie in a (horizontal) plane beneath the first conveyer belt 40. Each one of the first and second metallic rotors 54, 56 supports a plurality of permanent (neodymium) magnets 58 spaced slightly inwardly from a periphery or circumference of the front face of the metallic rotor 54, 56. As shown in FIG. 2, the second framework 28 also supports spaced apart mating first and second metallic rotors 54′, 56′ which both generally lie in a (horizontal) plane above the second conveyer belt 46. Each one of the metallic rotors 54, 54′, 56, 56′ supports a plurality of permanent (neodymium) magnets 58 spaced slightly inwardly from a periphery or circumference of the front face of the respective metallic rotor 54, 54′, 56, 56′. The first and second metallic rotors 54, 56 rotate in a first plane while the spaced apart mating first and second metallic rotors 54′, 56′ rotate in a second plane and the first and the second planes are spaced apart from but parallel to one another.

Typically an even number of permanent magnets 58 are supported and arranged around the periphery of the front face of each one of the metallic rotors 54, 54′, 56, 56′. Generally, each magnet 58 is accommodated within a magnet recess (not shown in detail) which is formed or machined into the front surface of the metallic rotor 54, 54′, 56, 56′. As shown in FIG. 4 for example, a total of 16 magnet recesses are formed in the front surface of the first and the second metallic rotors 54 and 56 and each magnet recess respectively accommodates one of the sixteen magnets 58. Similarly, a total of 16 magnet recesses are formed in the front surface of the mating first and the second metallic rotors 54′ and 56′ and each magnet recess respectively accommodates a respective one of the sixteen magnets 58.

It is to be appreciated that the total number of magnets 58, supported by each one of the metallic rotors 54, 54′, 56, 56′, can be increased or decreased, depending upon the particular application at hand. Further, it is also to be appreciated that the total number and/or size of each one of the magnets 58 and the associated magnet recesses, formed in the front surface of each one of the metallic rotors 54, 54′, 56, 56′, may vary as well depending upon the application.

Generally, all of the magnets 58 are of the same shape and/or size and generally have the same magnetic field strength, e.g., the magnets 58 are all either ring segments or cylindrical, square, semicircular or have a similar shape. Preferably the front surface of each of the metallic rotors 54, 54′, 56, 56′ carries or supports magnets 58 which have a similar or an identical field strength of between 1,000 to 7,000 gauss.

Each metallic rotor 54, 54′, 56, 56′ typically has a diameter of between 12 inches and 24 inches, for example, and has a thickness of between about ½ inch to about 2 inches or so. A hub 60 is integrally formed with a rear surface of each one of the metallic rotors 54, 54′, 56, 56′ and the hub 60, in turn, supports a first end of a shaft (not labeled). The opposite end of the shaft engages with a respective rotor motor or drive 62, 62′, 64, 64′ to facilitate rotation of the supported metallic rotor 54, 54′, 56 and 56′, as well as all of the supported magnets 58, in a desired rotational direction (e.g., either clockwise or counter clockwise) and at a desired rotational speed (e.g., a rotational speed of between 1,000 RPM and 4,000 RPM).

An air gap 66, e.g., of about 0.5 inches, is formed between the rear surface of the first conveyor belt 40 and the upwardly facing flat surface of the magnets 58 and/or the metallic rotors 54 and 56, while a similar air gap 66′, e.g., of about 0.5 inches, is formed between the rear surface of the second conveyor belt 46 and the downwardly facing flat surface of the magnets 58 and/or the mating metallic rotors 54′ and 56′ supported by the second framework 28. The first and second conveyor belts 40, 46 act as barriers so as to minimize air turbulence experienced by the (translucent) insulation panel 2 as the (translucent) insulation 2 panel passes through the panel passageway 31 of the magnetic heating apparatus.

As shown in FIG. 2 for example, it is important that each first metallic rotor 54 of the first framework 26 is paired or mated with a mating first metallic rotor 54′ of the second framework 28, i.e., paired or mated with a mating metallic rotor which is aligned parallel therewith, is located concentric therewith, and is located closely adjacent thereto but is spaced and separated therefrom by the panel passageway 31 and the two conveyor belts 40, 46. The magnetic poles of each one of the magnets 58, carried or supported by the first metallic rotor 54, are oriented in alternating directions, e.g., north (N)/south (S)/north (N)/south (S)/north (N)/south(S), etc., about the periphery of the rotor so that half of the magnets 58 of the first metallic rotor 54 have their north poles facing toward a rear surface of the first conveyor belt 40 while the other half of the magnets 58 of the first metallic rotor 54 have their south poles facing toward a rear surface of the first conveyor belt 40 (e.g., the alternating north (N) and south(S) magnetic polarities is shown for a few magnets in FIG. 4). That is, the pair of magnets, located on either side of any magnet 58 carried or supported by the first metallic rotor 54, have the same polarity which is opposite to a polarity of the magnet located therebetween. In addition, all of the magnets 58 of the mating first metallic rotor 54′ are similarly configured. That is, all of the magnets 58 carried or supported by the mating first metallic rotor 54′ are oriented in alternating directions, e.g., north (N)/south (S)/north (N)/south (S)/north (N)/south(S), etc., about the periphery of the rotor so that half of the magnets 58 of the mating first metallic rotor 54′ have their north poles facing toward a rear surface of the second conveyor belt 46 while the other half of the magnets 58 of the mating first metallic rotor 54′ have their south poles facing toward a rear surface of the second conveyor belt 46. Accordingly, the adjacent two magnets, directly located on either side of any magnet 58, have the same polarity which is opposite to a polarity of the magnet located therebetween. As a result of this arrangement, the magnets 58, for the first metallic rotor 54 and the mating first metallic rotor 54′, face one another and thus create a magnetic field MF between the first metallic rotor 54 and the mating first metallic rotor 54′.

In order to increase the potential of the magnetic field MF, e.g., eddy currents in this instance, generated between the first metallic rotor 54 and the mating first metallic rotor 54′, the first rotor drive 62 is configured to rotate the first metallic rotor 54 in a first rotational direction, e.g., clockwise or counterclockwise, while the second rotor drive 62′ is configured to rotate the mating first metallic rotor 54′ in a second opposite rotational direction, e.g., counterclockwise or clockwise. The first and the second rotor drives 62, 62′ generally rotate the associated metallic rotor 54 or 54′ at substantially the same speed, but in opposite rotational directions to one another. Such rotation of the mating pair of metallic rotors 54, 54′, carrying or supporting magnets 58 having alternating polarities, in opposite rotational directions thereby increases, the intensity of the generated magnetic field MF (e.g., eddy currents) in the panel passageway 31 which is defined between the first metallic rotor 54 and the first mating metallic rotor 54′.

As a result of this, as an assembled (translucent) insulation panel 2, to be manufactured, is conveyed through the panel passageway 31, the magnetic field MF (e.g., eddy currents) generated by the rotating magnets 58 energize and directly heat the metallic core 4, without directly heating any of the remaining non-metallic components of the (translucent) insulation panel 2, such as the fiberglass sheets 18, 22, the insulating material 20 or the applied bonding adhesive 16. Moreover, such heating of the metallic core 4, by the magnetic field, facilitates the metallic core 4 conducting a portion of its heat to the bonding adhesive 16 applied to the faces 12, 14 of the metallic core 4. Since the bonding adhesive 16 is a thermally activated or a temperature sensitive adhesive, such indirect heating by the metallic core 4 sufficiently softens and activates the bonding adhesive 16 so as to facilitate permanently bonding of the fiberglass sheets 18, 22 to the opposed faces 12, 14 of the metallic core 4.

As shown in the Figures, each of the first and second magnetic rotors 54 and 56 of the first framework are oriented adjacent one another but in a staggered or in a diagonal relationship with respect to one another. Similarly, each of the mating first and second magnetic rotors 54′ and 56′ of the second framework are oriented adjacent one another but also in a staggered or in a diagonal relationship with respect to one another. The staggered or diagonal relationship of the first and second magnetic rotors 54 and 56 and the mating first and second magnetic rotors 54′ and 56′ is designed to ensure that a substantially uniform generation of eddy currents is created across the entire transverse width of the panel passageway 31 and thereby ensure substantially uniform heating of the metallic core 4 as the assembled (translucent) insulation panel 2 is conveyed through the panel passageway 31 from the entrance of the panel passageway 31 to the exit of the panel passageway 31.

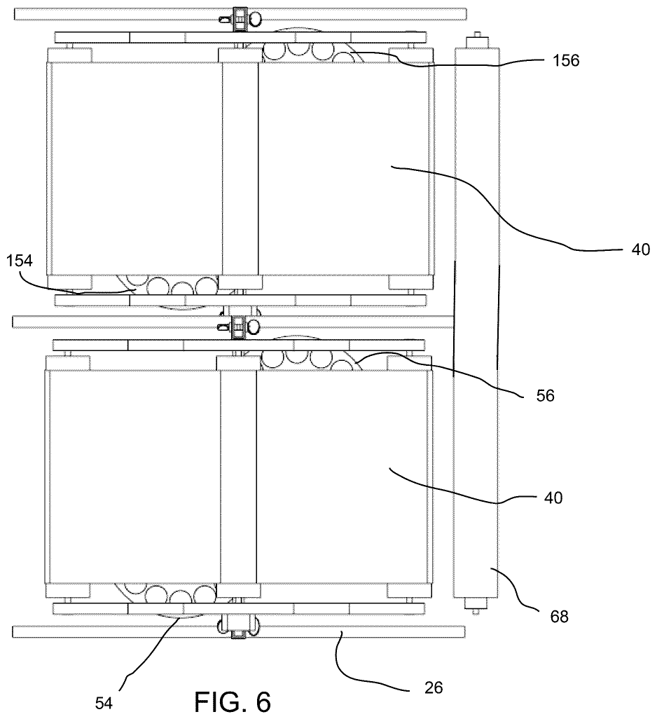

The magnetic heating apparatus 24, shown in FIGS. 2-4, is designed to accommodate a (translucent) insulation panel 2 having a width of between about 12 to about 48 inches or so. In order to manufacture (translucent) insulation panels 2 having greater widths, the staggered arrangement of the first and the second magnetic rotors 54 and 56 is merely repeated, in the transverse or lateral direction, e.g., at least one additional lateral set of first and second magnetic rotors 154 and 156 (see FIG. 6) along with mating first and second magnetic rotors (not shown in detail but generally shown in FIG. 2) are provided. Typically, the length of the associated rollers, conveyers, etc., are also lengthened in order to increase the overall width of the panel passageway 31 so that the magnetic heating apparatus 24 can adequately accommodate and heat wider assembled (translucent) insulation panels 2, e.g., (translucent) insulation panels 2 having a width of 3 ½ feet or greater, for example.

Alternatively and/or in addition thereto, the staggered arrangement of the first and the second magnetic rotors 54 and 56 may be repeated in the longitudinal direction of the magnetic heating apparatus 24 (i.e., in the conveying direction of the (translucent) insulation panel 2) in order to increase the throughput production speed of the magnetic heating apparatus 24. That is, at least one additional conveying set of first and second magnetic rotors 54A and 56A (see FIG. 7) along with mating first and second magnetic rotors (not shown in detail but generally shown in FIG. 2) are provided. The first set or section of the magnetic heating apparatus 24, i.e., the first and the second magnetic rotors 54 and 56 and the mating first and second magnetic rotors 54′ and 56′ provide initial heating of the metallic core 4 of the assembled (translucent) insulation panel 2, while each subsequent set(s) or section(s) of the magnetic heating apparatus 24 in the conveying direction (e.g., the next conveying section of the first and the second magnetic rotors 54A and 56A and the first and second mating magnetic rotors (not shown in detail) of each subsequent conveying section(s)) will complete the heating process of the metallic core 4 prior to the assembled (translucent) insulation panel 2 exiting from the panel passageway 31 at its optimum heated temperature and then passing through the mating pair of nip rollers 68 to permanently bond the fiberglass sheets 18, 22 to the opposed faces 12, 14 of the metallic core 4.

It is to be noted that heating of the metallic core 4, without directly heating any of the remaining non-metallic components of the (translucent) insulation panel 2, such as the fiberglass sheets 18, 22, the insulating material 20 or the applied bonding adhesive 16, can be achieved by employing either a single metallic rotor 54, 54′, 54A, 154, 56, 56′, 56A or 156′ or two or more metallic rotor 54 and 56; 54′ and 56′; 54A, 56A; 154, 156 which are arranged in a staggered or in a diagonal relationship with respect to one another and lie in a common (e.g., horizontal, vertical, etc.) plane. As a result, the metallic core 4 is heated from only one side by one or more of the staggered or diagonally arranged metallic rotors 54, 54′, 54A, 154, 56, 56′, 56A or 156′ which are all located in a common plane (e.g., either above or below or on one side or the other of the panel passageway 31). This embodiment works well when the metallic core 4 is not thermally broken and thus is able to readily transfer or conduct the heat from one face 12 of the metallic core 4 to the other face 14, and vice versa. When the metallic core 4 is thermally broken, the mating pair of rotors, which heat the metallic core 4 from opposed faces 12, 14 thereof, typically facilitate more rapid and efficient heating of the metallic core 4 to the desired temperature.

It is to be appreciated that the (translucent) insulation panels 2 may have a thickness of anywhere between about 1 inch to about 8 inches or so. The spacing between the nip rollers 68 is adjustable, in a conventional manner, so as to accommodate different heights or thicknesses of the (translucent) insulation panel 2. The important feature is that the spacing between the pair of nip rollers 68 is adjustable, in some manner, to allow pressing of the fiberglass sheets 18, 22 against the respective faces 12, 14 of the metallic core 4 to permanently bond the fiberglass sheets 18, 22 to the metallic core 4. That is, typically some sort of conventional relative adjustment is provided, between the first and the second rollers of the nip 68, in order to accommodate (translucent) insulation panels 2 which have different heights or sizes. A typical manufactured (translucent) insulation panel 2, having a thickness of 2-¾″, has a 0.05 U-factor (R-20).

Eddy currents are the result of Lenz's law, [symbol] =−dΦB/dt, which indicates that the electromotive force induced ε is equal and opposite to the magnetic flux per unit time which caused it. This translates to a physically resistive force opposing the motion of magnets near a paramagnetic body, like the aluminum core 4, for example. As a consequence of overcoming this resistive force, heat is generated in the paramagnetic object, e.g., the metallic core 4, as the induced currents resistively heat it. The rate at which energy enters the paramagnetic object, e.g., the metallic core 4, is a function of the magnet speed and distance (local field strength). Both factors simplify to flux—more change in field per unit time means more electromotive force.

Applying these theories and laws to the first and the second magnetic rotors 54, 54′, 154, 54A, 56, 56′, 156 and 56A, etc., it was found that due to the inverse square law nature of magnetic fields (although this becomes a bit convoluted with the introduction of other magnets 58 in the local area), heat generated is roughly proportional to the inverse square of the distance from the magnet to the paramagnetic object, e.g., the metallic core 4. Likewise, the apparent “drag force” each magnet experiences increases proportionally with the speed. Since work is the product of force and distance, and power is work per unit time, power into the paramagnetic object, e.g., the metallic core 4, is proportional to the square of the speed. Through experimentation, it was found that these mathematical models did not perfectly reflect the data collected. Due to an amalgamation of factors, like the very rough inverse square model of the magnets 58 and the additional variables like convective/conductive cooling, the actual results differed. From real world testing, the magnet distance was found to more closely resemble a linear relationship than square, with the rotor speed exhibiting similar characteristics. For example, it was calculated that by doubling the rotational speed of the first and second magnetic rotors 54, 54′, 154, 54A, 56, 56′, 156 and 56A, etc., the heat generated would increase four-fold. However, during testing, the heat into the metallic (aluminum) core 4 was determined to be somewhere closer to two and a half times greater.

Notably, the induction of electrical current in a conductor can be set forth by a coil of wire, using a specific frequency and amplitude AC voltage, as prescribed by the material being heated. This avenue is promising for repeatable, similar objects whose induction coils can be fine-tuned to improve effectiveness and efficiency. For current application, this method still has merit. However, spinning motors with magnets 58 attached to magnetic rotors 54, 54′, 154, 54A, 56, 56′, 156 and 56A, etc., is a great alternative, the efficiency of heating the metal remains constant, and any geometry can be presented to the rotors without further complication or tuning.

While various embodiments of the present invention have been described in detail, it is apparent that various modifications and alterations of those embodiments will occur to and be readily apparent to those skilled in the art. However, it is to be expressly understood that such modifications and alterations are within the spirit and scope of the present disclosure, as set forth in the appended claims. Further, the invention(s) described herein is capable of other embodiments and of being practiced or of being carried out in various other related ways. In addition, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items while only the terms “consisting of” and “consisting only of” are to be construed in the limitative sense.

What is claimed is:

1. A magnetic heating apparatus comprising:
a first rotor supporting a plurality of first permanent magnets in an alternating directions about a periphery thereof such that each pair of magnets, located directly on either side of any one of the first permanent magnets, have the same polarity which is opposite to a polarity of the magnet located therebetween;
the plurality of first permanent magnets being spaced from a panel passageway which facilitates passage of an assembled insulation panel, having a metallic core, therethrough; and
a first rotor drive for rotating the first rotor, supporting the plurality of first permanent magnets, relative to the panel passageway in order to generate a changing magnetic field, in the panel passageway, for directly heating the metallic core of the assembled insulation panel as the assembled insulation panel passes therethrough.

2. A magnetic heating apparatus comprising:
a first rotor supporting a plurality of first permanent magnets;
a mating first rotor supporting a plurality of second permanent magnets;
polarities of the first plurality of permanent magnets, supported by the first rotor, being arranged in alternating directions such that each pair of magnets, located directly on either side of any one of the first plurality of permanent magnets, have the same polarity which is opposite to a polarity of the magnet located therebetween, while polarities of the plurality of second permanent magnets, supported by the mating first rotor, being arranged in alternating directions such that each pair of magnets, located directly on either side of any one of the second plurality of magnets, have the same polarity which is opposite to a polarity of the magnet located therebetween;
the plurality of first permanent magnets of the first rotor being spaced from the plurality of second permanent magnets of the mating first rotor so as to define a panel passageway therebetween which facilitates passage of an assembled insulation panel, having a metallic core with opposed faces thereof having a heat activated adhesive applied thereto, and a pair of fiberglass sheets sandwiching the metallic core with the heat activated adhesive therebetween;
a first rotor drive for rotating the first rotor, supporting the plurality of first permanent magnets in a first rotatable direction, and a mating first rotor drive for rotating the mating first rotor, supporting the plurality of second permanent magnets, in an opposite second rotatable direction in order to generate a changing magnetic field, in the panel passageway, for directly heating the metallic core of the assembled insulation panel, as the assembled insulation panel passes therethrough, and thereby indirectly heating the heat activated adhesive, applied to opposed faces of the metallic core, to facilitate bonding of the pair of fiberglass sheets to the metallic core.

3. The magnetic heating apparatus according to claim 2, wherein the magnetic heating apparatus further comprises a second rotor supporting a plurality of first permanent magnets;
a mating second rotor supporting a plurality of second permanent magnets;
polarities of the first plurality of permanent magnets, supported by the second rotor, being arranged in alternating directions such that each pair of magnets, located directly on either side of any one of the first plurality of permanent magnets of the second rotor, have the same polarity which is opposite to a polarity of the magnet located therebetween, while polarities of the plurality of second permanent magnets, supported by the mating second rotor, being arranged in alternating directions such that each pair of magnets, located directly on either side of any one of the second plurality of magnets of the mating second rotor, have the same polarity which is opposite to a polarity of the magnet located therebetween;
the plurality of first permanent magnets, of the second rotor, being spaced from the plurality of second permanent magnets, of the mating second rotor, so as to define further the panel passageway therebetween;
a second rotor drive for rotating the second rotor, supporting the plurality of first permanent magnets, in a first rotational direction, and a mating second rotor drive for rotating the mating second rotor, supporting the plurality of second permanent magnets, in an opposite second rotational direction in order to generate a changing magnetic field, in the panel passageway, for directly heating the metallic core of the assembled insulation panel, as the assembled insulation panel passes therethrough, and thereby indirectly heating the heat activated adhesive, applied to opposed faces of the metallic core, to facilitate bonding of the pair of fiberglass sheets to the metallic core.

4. The magnetic heating apparatus according to claim 2, wherein the first framework is stationary and the second framework is vertically adjustable relative to the first framework.

5. The magnetic heating apparatus according to claim 4, wherein the first framework supports a pair of spaced apart posts while the second framework supports a pair of mating collars which captively surround and slidingly engage with a respective one of the pair of posts, and each one of the sliding collars has set screw to facilitate retaining the second framework in a desired adjusted position with respect to the first framework.

6. The magnetic heating apparatus according to claim 3, wherein a height of the panel passageway, which permits passage of the assembled insulation panel therethrough, is adjustable by adjustment of the position of the second framework relative to the first framework.

7. The magnetic heating apparatus according to claim 3, wherein each one of the first and the second frameworks is equipped with a conveyer belt which facilitates conveying of the assembled insulating panel through the panel passageway of the magnetic heating apparatus.

8. The magnetic heating apparatus according to claim 7, wherein each the conveyor belts, of the first and the second frameworks, is supported by a plurality of rollers and each conveyor belt is driven by a respective conveyor motor.

9. The magnetic heating apparatus according to claim 7, wherein the assembled insulating panel is sandwiched between the conveyor belt of the first framework and the conveyor belt of the second framework as the assembled insulating panel is conveyed through the panel passageway.

10. The magnetic heating apparatus according to claim 8, wherein at least one of the conveyor belts of the first framework and the second framework comprises a plurality of conveyer belts which are located adjacent to but spaced apart from one another and extend substantially across a full width of the respective rollers to facilitate conveying of the insulation panel through the panel passageway of the magnetic heating apparatus.

11. The magnetic heating apparatus according to claim 8, wherein at least one of the conveyor belts of the first framework and the second framework comprises a single conveyer belt which extends substantially across a full width of the respective rollers to facilitate conveying of the insulation panel through the panel passageway of the magnetic heating apparatus.

12. The magnetic heating apparatus according to claim 2, wherein the first rotor rotates in a first plane while the mating first rotor rotates in a second plane and the first and the second planes are spaced apart from but parallel to one another.

13. The magnetic heating apparatus according to claim 2, wherein an even number of magnets is arranged around a periphery of a front face of each one of the first rotor and the mating first rotor, and
each one of the magnets have a similar or an identical field strength of between 1,000 to 7,000 gauss.

14. The magnetic heating apparatus according to claim 2, wherein the first rotor drive and the mating first rotor drive both rotate the respective rotors at a rotational speed of between 1,000 RPM and 4,000 RPM.

15. The magnetic heating apparatus according to claim 2, wherein each rotor has a diameter of between 12 inches and 24 inches, and has a thickness of between about ½ inch to about 2 inches, and
a hub, which supports a first end of a shaft, is integrally formed with a rear surface of each one of the rotors.

16. The magnetic heating apparatus according to claim 2, wherein the magnetic heating apparatus comprises at least one further lateral first rotor supporting a first plurality of permanent magnets, and a lateral mating first rotor supporting a second plurality of permanent magnets to facilitate heating of an assembled insulation panel having a wider width; and
polarities of the first plurality of permanent magnets, supported by the lateral first rotor, are arranged in alternating directions such that each pair of magnets, located directly on either side of any one of the first plurality of permanent magnets of the lateral first rotor, have the same polarity which is opposite to a polarity of the magnet located therebetween, while polarities of the plurality of second permanent magnets, supported by the lateral mating first rotor, are arranged in alternating directions such that each pair of magnets, located directly on either side of any one of the second plurality of magnets of the lateral mating first rotor, have the same polarity which is opposite to a polarity of the magnet located therebetween.

17. The magnetic heating apparatus according to claim 16, wherein the magnetic heating apparatus comprises at least one further lateral second rotor supporting a first plurality of permanent magnets, and a lateral mating second rotor supporting a second plurality of permanent magnets to facilitate heating of an assembled insulation panel having a wider width; and
polarities of the first plurality of permanent magnets, supported by the lateral second rotor, are arranged in alternating directions such that each pair of magnets, located directly on either side of any one of the first plurality of permanent magnets of the lateral second rotor, have the same polarity which is opposite to a polarity of the magnet located therebetween, while polarities of the plurality of second permanent magnets, supported by the lateral mating second rotor, are arranged in alternating directions such that each pair of magnets, located directly on either side of any one of the second plurality of magnets of the lateral mating second rotor, have the same polarity which is opposite to a polarity of the magnet located therebetween.

18. The magnetic heating apparatus according to claim 2, wherein the magnetic heating apparatus comprises at least one further conveying first rotor supporting a first plurality of permanent magnets, and a conveying mating first rotor supporting a second plurality of permanent magnets to facilitate heating of an assembled insulation panel and increase a throughput production speed of the magnetic heating apparatus; and
polarities of the first plurality of permanent magnets, supported by the conveying first rotor, are arranged in alternating directions such that each pair of magnets, located directly on either side of any one of the first plurality of permanent magnets of the conveying first rotor, have the same polarity which is opposite to a polarity of the magnet located therebetween, while polarities of the plurality of second permanent magnets, supported by the conveying mating first rotor, are arranged in alternating directions such that each pair of magnets, located directly on either side of any one of the second plurality of magnets of the conveying mating first rotor have the same polarity which is opposite to a polarity of the magnet located therebetween.

19. The magnetic heating apparatus according to claim 18, wherein the magnetic heating apparatus comprises at least one further conveying second rotor supporting a first plurality of permanent magnets, and a conveying mating second rotor supporting a second plurality of permanent magnets to facilitate heating of an assembled insulation panel and increase the throughput production speed of the magnetic heating apparatus; and
polarities of the first plurality of permanent magnets, supported by the conveying second rotor, are arranged in alternating directions such that each pair of magnets, located directly on either side of any one of the first plurality of permanent magnets of the conveying second rotor, have the same polarity which is opposite to a polarity of the magnet located therebetween, while polarities of the plurality of second permanent magnets, supported by the conveying mating second rotor, are arranged in alternating directions such that each pair of magnets, located directly on either side of any one of the second plurality of magnets of the conveying mating second rotor, have the same polarity which is opposite to a polarity of the magnet located therebetween.

20. A method of magnetic heating an assembled insulation panel, the method comprising:
a first rotor supporting a plurality of first permanent magnets;
a mating first rotor supporting a plurality of second permanent magnets;
supporting polarities of a first plurality of permanent magnets, supported by a first rotor, in alternating directions such that each pair of magnets, located directly on either side of any one of the first plurality of permanent magnets of the first rotor, have the same polarity which is opposite to a polarity of the magnet located therebetween, while polarities of a plurality of second permanent magnets, supported by a mating first rotor, being arranged in alternating directions such that each pair of magnets, located directly on either side of any one of the second plurality of magnets, have the same polarity which is opposite to a polarity of the magnet located therebetween;
spacing the plurality of first permanent magnets of the first rotor from the plurality of second permanent magnets of the mating first rotor so as to define a panel passageway therebetween which facilitates passage of an assembled insulation panel, having a metallic core with opposed faces thereof having a heat activated adhesive applied thereto, and a pair of fiberglass sheets sandwiching the metallic core with the heat activated adhesive therebetween;
rotating the first rotor, supporting the plurality of first permanent magnets in a first rotational direction, and rotating the mating first rotor, supporting the plurality of second permanent magnets, in an opposite second rotational direction in order to generate a changing magnetic field, in the panel passageway; and
directly heating the metallic core of the assembled insulation panel as the assembled insulation panel passes therethrough, and thereby indirectly heating the heat activated adhesive, applied to opposed faces of the metallic core, to facilitate bonding of the pair of fiberglass sheets to the metallic core.
